(19) United States
(12) Patent Application Publication
(10) Pub. No.: US 2024/0340067 A1
(43) Pub. Date: Oct. 10, 2024

(54) USER EQUIPMENT DYNAMIC SCALING BEAM SWEEPING FACTOR REPORTING

(71) Applicant: Nokia Technologies Oy, Espoo (FI)

(72) Inventors: Rupali GUPTA, Bangalore (IN); Rafael CAUDURO DIAS DE PAIVA, Aalborg (DK); Christian ROM, Aalborg (DK); Vinayak BELLUR, Bangalore (IN)

(21) Appl. No.: 18/624,887

(22) Filed: Apr. 2, 2024

(30) Foreign Application Priority Data
Apr. 10, 2023 (IN) 202341026678

(51) Int. Cl. H04B 7/06; H04W 72/044; H04W 72/21

(52) U.S. Cl. CPC H04B 7/06952; H04W 72/046; H04W 72/21

(57) ABSTRACT

User equipment dynamic scaling beam sweeping factor reporting is provided. A method for user equipment dynamic scaling beam sweeping factor reporting may include transmitting, to a network entity, capability information for supporting a dynamic beam sweeping factor by the apparatus. The dynamic beam sweeping factor may be adaptable over a range of values. The method may further include transmitting the dynamic beam sweeping factor to the network entity in assistance information of the apparatus over an uplink control channel.

### CROSS-REFERENCE TO RELATED APPLICATIONS

This application claims priority to, and the benefit of, IN provisional application No. 202341026678 filed 10 Apr. 2023, which is incorporated herein by reference in its entirety.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to user equipment dynamic scaling beam sweeping factor reporting.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. The instructions, when executed by the at least one processor, cause the apparatus at least to transmit, to a network entity, capability information for supporting a dynamic beam sweeping factor by the apparatus. The dynamic beam sweeping factor may be adaptable over a range of values. The apparatus may also be caused to transmit the dynamic beam sweeping factor to the network entity in assistance information of the apparatus over an uplink control channel.

Certain exemplary embodiments may provide an apparatus including at least one processor and at least one memory storing instructions. The instructions, when executed by the at least one processor, cause the apparatus at least to receive, from a user equipment, capability information indicating support for a dynamic beam sweeping factor by the user equipment, and assistance information including the dynamic beam sweeping factor. The dynamic beam sweeping factor may be adaptable over a range of values. The apparatus may also be caused to modify at least one measurement parameter for multiple reception configuration based on a value of the dynamic beam sweeping factor.

Some exemplary embodiments may provide a method including transmitting, to a network entity, capability information for supporting a dynamic beam sweeping factor by an apparatus. The dynamic beam sweeping factor may be adaptable over a range of values. The method may also include transmitting the dynamic beam sweeping factor to the network entity in assistance information of the apparatus over an uplink control channel.

Various exemplary embodiments may provide a method including receiving, from a user equipment, capability information indicating support for a dynamic beam sweeping factor by the user equipment, and assistance information including the dynamic beam sweeping factor. The dynamic beam sweeping factor may be adaptable over a range of values.

Some exemplary embodiments may provide an apparatus including means for transmitting, to a network entity, capability information for supporting a dynamic beam sweeping factor by the apparatus. The dynamic beam sweeping factor may be adaptable over a range of values. The apparatus may also include means for transmitting the dynamic beam sweeping factor to the network entity in assistance information of the apparatus over an uplink control channel.

Certain exemplary embodiments may provide an apparatus including means for receiving, from a user equipment, capability information indicating support for a dynamic beam sweeping factor by the user equipment, and assistance information comprising the dynamic beam sweeping factor. The dynamic beam sweeping factor may be adaptable over a range of values. The apparatus may also include means for modifying at least one measurement parameter for multiple reception configuration based on a value of the dynamic beam sweeping factor.

Various exemplary embodiments may provide a non-transitory computer readable medium including program instructions that, when executed by an apparatus, cause the apparatus at least to transmit, to a network entity, capability information for supporting a dynamic beam sweeping factor by the apparatus. The dynamic beam sweeping factor may be adaptable over a range of values. The apparatus may also be caused to transmit the dynamic beam sweeping factor to the network entity in assistance information of the apparatus over an uplink control channel.

Some exemplary embodiments may provide a non-transitory computer readable medium including program instructions that, when executed by an apparatus, cause the apparatus at least to receive, from a user equipment, capability information indicating support for a dynamic beam sweeping factor by the user equipment, and assistance information including the dynamic beam sweeping factor. The dynamic beam sweeping factor may be adaptable over a range of values. The apparatus may also be caused to modify at least one measurement parameter for multiple reception configuration based on a value of the dynamic beam sweeping factor.

Various exemplary embodiments may provide one or more computer programs including instructions stored thereon for performing one or more of the methods described herein. Some exemplary embodiments may also provide one or more apparatuses including one or more circuitry configured to perform one or more of the methods described herein.

### BRIEF DESCRIPTION OF THE DRAWINGS

For proper understanding of example embodiments, reference should be made to the accompanying drawings, as follows:

FIG. 1 illustrates examples of enhanced user equipment (UE) with simultaneous downlink (DL) reception;

FIG. 2 illustrates an example of a simplified single polarization mm Wave array;

FIG. 3 illustrates exemplary UE mmWave radio frequency (RF) front end simplified architecture representations;

FIG. 4 illustrates an exemplary signal diagram of one or more procedures involving a UEAssistanceInformation message, according to various exemplary embodiments;

FIG. 5 illustrates various examples of configurations related to reporting dynamic beam sweeping factor N_fac, according to certain exemplary embodiments;

FIG. 6 illustrates an exemplary flow diagram of the examples of FIG. 5, according to various exemplary embodiments;

FIG. 7A illustrates an example of a network protocol message that may include the UECapabilityInformation, according to some exemplary embodiments;

FIG. 7B illustrates an example of a network protocol message that may include the UEAssistanceInformation, according to various exemplary embodiments;

FIG. 8 illustrates an example of a flow diagram of a method, according to certain exemplary embodiments;

FIG. 9 illustrates an example of a flow diagram of another method, according to some exemplary embodiments; and

FIG. 10 illustrates a set of apparatuses, according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for user equipment (UE) dynamic scaling beam sweeping factor reporting. Although the devices discussed below and shown in the figures refer to 5G or Next Generation NodeB (gNB) devices and user equipment devices, this disclosure is not limited to only gNBs and UEs.

It may be readily understood that the components of certain example embodiments, as generally described and illustrated in the figures herein, may be arranged and designed in a wide variety of different configurations. Different reference designations from multiple figures may be used out of sequence in the description, to refer to a same element to illustrate their features or functions. If desired, the different functions or procedures discussed herein may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In 5G/NR technology, as well as LTE, multiple input multiple output (MIMO) networks may be implemented by a radio access network (RAN) and may be formed of a plurality of antenna arrays at a base station that serve multiple users via associated user equipment (UE) using the same time-frequency resources. MIMO networks use a multipath effect to obtain diversity and multiplexing gain, which increase the link rate and reduce the bit error rate. The MIMO network may be formed by channels between the antennas of the base station and the multiple user equipment communicating with the antennas of the base station. To establish communication, the channel may be estimated using signals, which are also referred to as pilots, that use known information and a channel coefficient to form a channel.

Beamforming in the MIMO network may rely on accurate channel state information (CSI), which may be acquired via uplink pilots. Orthogonal pilots that may be assigned to different user equipment (UE) may not cause interference, or minimal interference, in the data transmission as compared to using non-orthogonal pilots. Non-orthogonal pilots and pilot reuse by different UE may result in pilot contamination that can severely compromise the quality of CSI estimation. Under traditional cellular MIMO networks, a set of orthogonal pilots in one cell may reach antennas of a base station of a neighboring cell and interfere with the pilots of that neighboring base station. A signal arriving at a base station is a linear combination of pilots from one user equipment in the same cell and another user equipment in the neighboring cell. All the pilots that are not completely orthogonal to the other pilot may cause interference in the uplink during training stage and in the downlink during the data transmission stage. For beyond-5G networks, a distributed MIMO (D-MIMO) topology may be suitable, where (a) the concept of cell is removed, (b) a given UE establishes connectivity to multiple access points (APs), and (c) the concept of interference is redefined.

4-layer MIMO reception may use beam reception from at least two directions. The beam reception may be simultaneous. The simultaneous reception may use a simultaneous multi-panel operation with several independent reception beams/chains at the UE side.

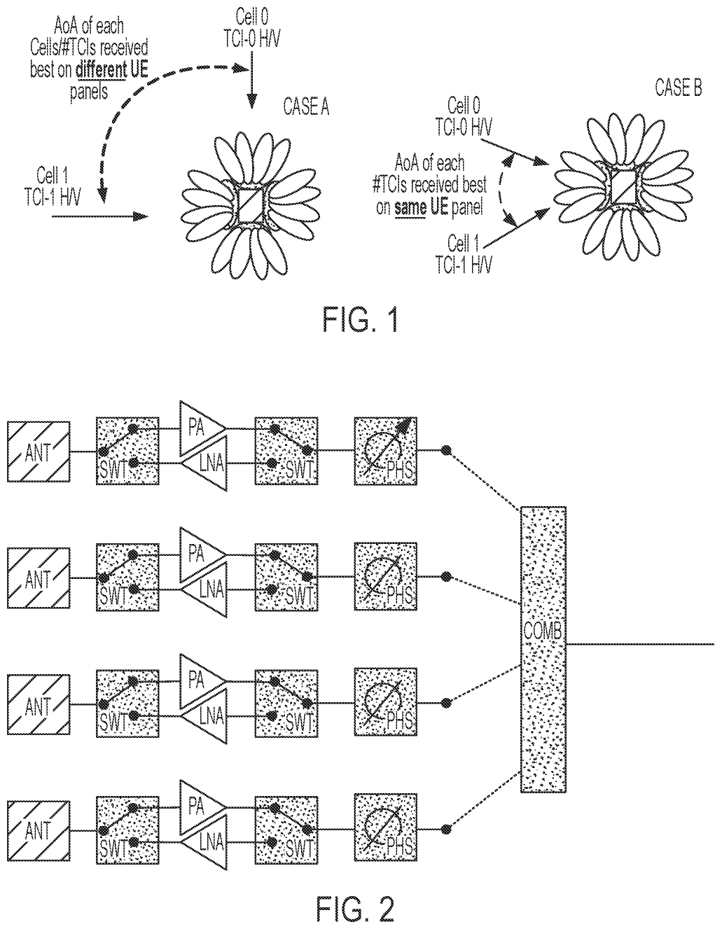

FIG. 1 illustrates two examples of enhanced UEs with simultaneous downlink (DL) reception. The simultaneous DL reception may have two different quasi colocation (QCL) TypeD reference signals (RSs) on a single component carrier. In a first example, referred to as case A, each transmission configuration indicator (TCI) may be received by different UE panels. In a second example, referred to as case B, each TCI may be received by one UE panel. Case A and case B may each have a 4-patch array with a structure covering a single polarisation. Each antenna element may be connected to a switch to handle a time division duplex (TDD) of a signal. In uplink (UL), the signal may be amplified by a power amplifier (PA). In DL, the signal may be amplified by a low noise amplifier (LNA) and may be followed by another switch, a bi-directional phase shifter (PHS), and a combiner (COMB).

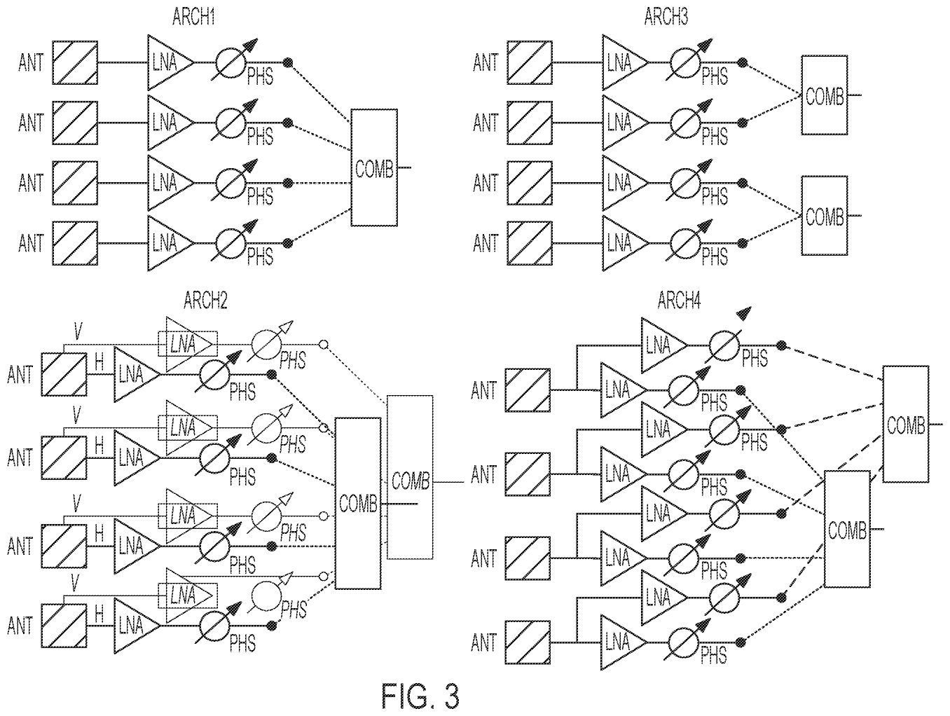

FIG. 2 illustrates an example of a simplified single polarization mmWave 4 patch array with bi-directional front end architecture. In the example of FIG. 2, an exemplary architecture (ARCH1) may be a simplified DL single polarization 4 patch combined steerable array, controls a single polarized beam. Another exemplary architecture (ARCH2) may be a simplified DL dual polarized (H+V) 4 patch combined steerable array, which controls 2 beams for each polarization respectively. A further exemplary architecture (ARCH3) may be referred to as a split array. The ARCH3 may be a simplified DL single polarization 2×2 patch combined steerable dual array. This architecture controls 2 beams in the same polarization, created each with 2 patches per beam. Another exemplary architecture (ARCH4) may be referred to as full hybrid analog digital (HAD) array, which enables multiple simultaneous beams to be created by supporting multiple feed points per antenna element in an mmWave module/array. The ARCH4 may be a simplified DL single polarization 4 patch combined steerable array, which controls 2 beams in the same polarization. The signal may be split after each antenna feeding point in such a way that the 2 beams exploit having maximum array gain, which relies on 4 patches in a single polarization, while being steered independently. The ARCH4 may enable from a single array of a panel to have 2 simultaneous beams with independent steering directions and associated RX-chains.

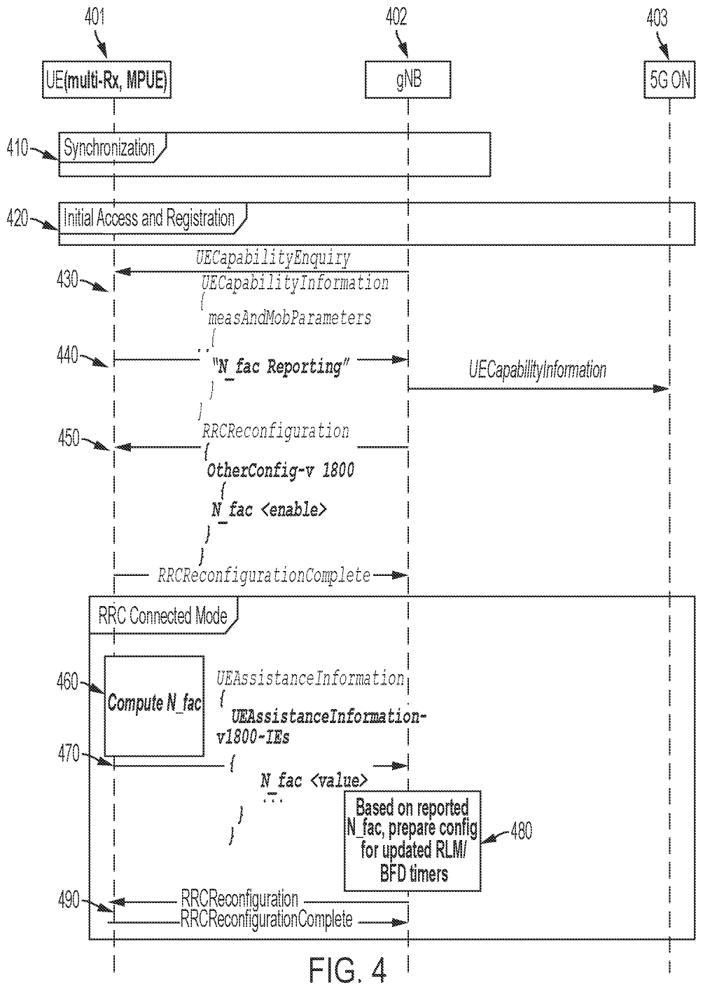

FIG. 3 illustrates exemplary UE mmWave radio frequency (RF) front end simplified architecture representations. ARCH1, ARCH3 and ARCH4 may all be single polarized versions and ARCH2 may have a dual polarized connection. ARCH2, ARCH3 and ARCH4 in context of 4-layer MIMO may use a double implementation that uses antenna elements in the opposite polarization such that there may be 4 combiners each carrying a MIMO layer. Certain exemplary embodiments may be a UE that may use a legacy architecture, such as ARCH2, or may use an advanced architecture with 2 simultaneous dual polarized RX chains, such as ARCH4.

Various exemplary embodiments may advantageously provide one or more procedures for optimizing a beam sweeping factor N for a mobile UE.

A layer 1 (L1) radio link monitoring reference signal (RLM-RS) measurement requirement in frequency range FR2-1 may be a factor of 8 slower than in frequency range FR1 due to the beam sweeping factor N to address a continuous UE FR2 beam panel selection and UE FR2 beam refinement. Various exemplary embodiments may provide that a UE may support shorter RLM evaluation due to mobility conditions, and thus may optimize an overall T_{Evaluate_out} and T_{Evaluate_in} by optimizing the beam sweeping factor N. T_{Evaluate_out} and T_{Evaluate_in} may be time periods in which the UE may evaluate and/or estimate whether the downlink radio link quality on the configured RLM-RS resource. As an example, the beam sweeping factor N may be 8 for the FR2-1 UE, and 12 for FR2-2 UE. Table 1 below may provide examples of evaluation periods of T_{Evaluate_out} and T_{Evaluate_in}.

TABLE 1

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10′ P′ | Max(100, Ceil(5′ P′ |
| | N)′ T_{SSB}) | N)′ T_{SSB}) |
| DRX cycle ≤ | Max(200, Ceil(15′ P′ | Max(100, Ceil(7.5′ P′ |
| 320 ms | N)′ Max(T_{DRX}, T_{SSB})) | N)′ Max(T_{DRX}, T_{SSB})) |
| DRX cycle > | Ceil(10′ P′ N)′ T_{DRX} | Ceil(5′ P′ N)′ T_{DRX} |
| 320 ms | | |

NOTE:
T_{SSB} is the periodicity of the SSB configured for RLM.
T_{DRX} is the DRX cycle length.

Table 2 may provide numerical examples of N factor calculation and associated L1 measurement periods for FR2-2 UE, as follows:

TABLE 2

| | | | | | L1 RSRP | |
|---|---|---|---|---|---|---|
| | | | | | measurement period | |
| TSSB | xRP | TSMTC | MGRP | N factor | No DRX | DRX = 320 |
| 20 | 40 | 80 | 40 | 12 | 2880 ms | 46.08 s |
| 20 | 80 | 40 | 80 | 12 | 2880 ms | 46.08 s |

Table 3 may provide numerical examples of N factor calculation and associated L1 measurement periods for FR2-1 UE, as follows:

TABLE 3

| | | | | | L1 RSRP | |
|---|---|---|---|---|---|---|
| | | | | | measurement period | |
| TSSB | xRP | TSMTC | MGRP | N factor | No DRX | DRX = 320 |
| 20 | 40 | 80 | 40 | 8 | 1920 ms | 30.72 s |
| 20 | 80 | 40 | 80 | 8 | 1920 ms | 30.72 s |

Table 4 may provide numerical examples of N factor calculation and associated L1 measurement periods for FR1 UE, as follows:

TABLE 4

| | | | | | L1 RSRP | |
|---|---|---|---|---|---|---|
| | | | | | measurement period | |
| TSSB | xRP | TSMTC | MGRP | N factor | No DRX | DRX = 320 |
| 20 | 40 | 80 | 40 | 1 | 240 ms | 3.84 s |
| 20 | 80 | 40 | 80 | 1 | 240 ms | 3.84 s |

Tables 2-4 shows examples with a synchronization signal block (SSB) periodicity of 20 ms, and one case without DRX and another case with DRX cycle=320 ms. The measurement time of L1 reference signal received power (RSRP) may be from approximately 2 seconds to 30 seconds if DRX is configured, whereas for a FR1 UE this measurement time of L1 RSRP may vary from approximately 0.2 seconds to 4 seconds. For example, in FR2-1, the range of measurement time may limit the reliability of the measurements, since the UE may have moved during the measurement. Similar timers may be used for RLM and/or radio link failure (RLF), which indicates that the UE would take several seconds for detecting radio link failure.

However, a UE capability may be too static to cover many typical UE scenarios. For example, a UE may be subject to static, dynamic, and high mobility radio conditions with varying angle of arrival (AOA) at the UE for each transmission reception point (TRP). The UE may need to inform the network about a dynamic radio condition to adapt the beam sweeping factor N. Further, the UE might not be operating with multiple panels continuously.

Various exemplary embodiments to provides advantages to address these concerns by the UE reporting, to the network, a dynamic beam sweeping factor N_fac to enhance a legacy static beam sweeping N factor. Certain exemplary embodiments may exploit 5G/NR UEs with multi-Rx capability in order to reach optimum reduction of RLM-RS measurement time. Some exemplary embodiments provide that the dynamic beam sweeping factor N_fac reporting may help to reduce an RLM and/or BFD evaluation period for both out-of-sync and in-sync criteria, when SSB-RS or CSI-RS are configured for measurements.

Certain exemplary embodiments may provide one or more procedures for a UE to detect whether the UE may perform a dynamic beam sweeping factor N_fac reporting itself and the UE calculates a dynamic beam sweeping factor N_fac. Various exemplary embodiments may also provide a UE that supports the capability to allow for a dynamic beam sweeping factor N_fac and the capability to perform N factor reporting dynamically. The reporting by the UE may enable the UE to report N_fac to the network.

Various exemplary embodiments provide advantages that allow for a UE having multi-Rx, multi-panel architectures, and/or supporting independent beam management, to reduce the impact of the beam sweeping factor N during RLM, BFD, and CBD resources for L1 measurements. The impact of the beam sweeping factor N may be further reduced by the UE supporting dynamic beam sweeping factor N_fac reporting.

During radio resource control (RRC) signaling, various exemplary embodiments may provide a UE with dynamic N_fac reporting procedures that support dynamic beam sweeping factor N_fac reporting. A UECapabilityInformation parameter/message may be defined to signal UE capability for reporting the dynamic beam sweeping factor N_fac. The UEAssistanceInformation message may be used for the indication of UE assistance information to the network.

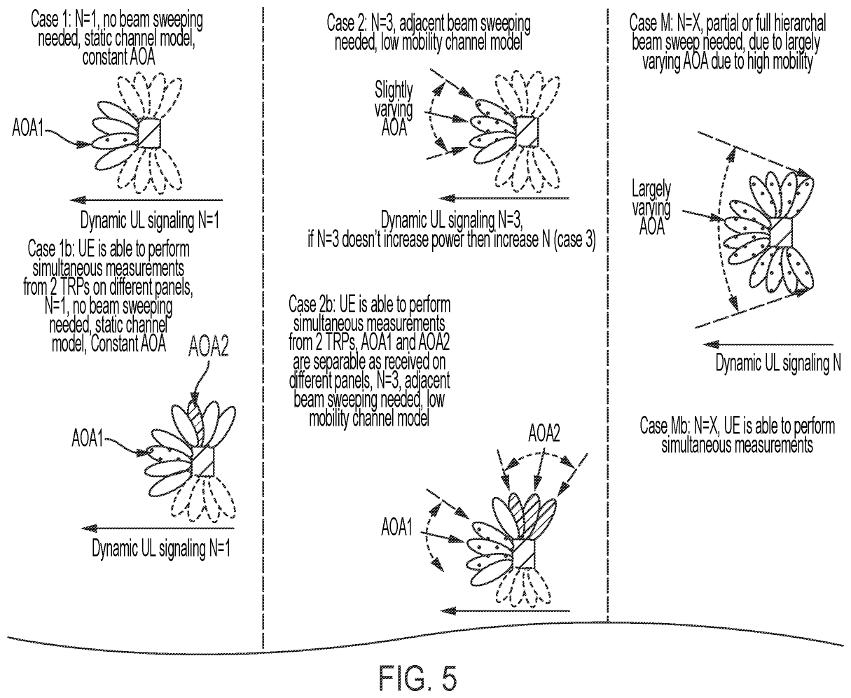

FIG. 4 illustrates an exemplary signal diagram of one or more procedures involving a UEAssistanceInformation message, according to various exemplary embodiments. In FIG. 4, a UE 401, a base station 402, such as a gNB, 402, and a network 403 may communicate with each other as shown.

In FIG. 4, at 410, the UE 401 may perform synchronization with the gNB 402, and at 420, the UE 401, the gNB 402, and the network 403 may perform initial access and registration. At 430, the gNB 402 may transmit a UECapabilityEnquiry message to the UE 401 to request information on the capabilities of the UE 401.

At 440, the UE 401 may generate a UECapabilityInformation message that indicates that the UE 401 has capabilities for performing and reporting the dynamic beam sweeping factor N_fac. The UE 401 may transmit the UECapabilityInformation message to the gNB 402 and/or the network 403. Alternatively, the UE 401 may transmit the UECapabilityInformation message to the gNB 402, and the gNB 402 may then transmit the information in the UECapabilityInformation message to the network 403. At 450, the gNB 402 may transmit, to the UE 401, an RRCReconfiguration message containing a multi-Rx configuration. The UE 401 may use information obtained from the gNB 402 and/or the network 403 to determine whether dynamic beam sweeping factor N_fac is supported. For example, if information indicating support for dynamic beam sweeping factor N_fac is not configured by the gNB 402, the UE 401 may not send a UEAssistanceInformation message/UECapabilityInformation message. If information indicates that dynamic beam sweeping factor N_fac is supported, the UE 401 may complete RRC configuration/reconfiguration and may transmit an RRCReconfigurationComplete message to the gNB 402.

At 460, in an RRC_Connected state, the UE 401 may determine a dynamic beam sweeping factor N_fac. The dynamic beam sweeping factor N_fac may be determined/calculated based on various network factors, such as, for example, a beam sweeping strategy, currently active TCI states and their respective AOA, and/or a spatial relationship of L1 reference signals that are configured for L1 RSRP, RLM, BFD, CBD, and the like. If the calculated dynamic beam sweeping factor N_fac is different than a current beam sweeping factor N, then the procedure may proceed to 470. If the calculated dynamic beam sweeping factor N_fac is the same as the current beam sweeping factor N, the UE 401 may wait and repeat the procedure of 460 until the dynamic beam sweeping factor N_fac is different than the current beam sweeping factor N. The dynamic beam sweeping factor N_fac may be changed over time due to, for example, movement of the UE 401.

At 470, the UE 401 may transmit a UL dedicated control channel (DCCH) to the gNB 402. The UL-DCCH may include UEAssistanceInformation, Multi-RxInfo and/or N_fac values. The UE 401 may provide an indication of a reduction in the beam sweeping factor N in the RRC_Connected state, upon calculating/determining, in procedure 460, the value of the dynamic beam sweeping factor N_fac based on radio conditions and the AOA. The UE 401, which may have the capability to perform the reporting a dynamic beam sweeping factor N_fac in the RRC_Connected state, may indicate its capability to the gNB 402 and/or network 403 by calculating and reporting the dynamic beam sweeping factor N_fac to the gNB 402 using the UL-DCCH.

At 480, the gNB 402 may adapt timers based on the calculated dynamic beam sweeping factor N_fac received from the UE 401. For example, the timers may be T310 and T311 timer values, SSB-based measurement timing configuration (SMTC) periodicity values, L1-RSRP reporting periodicity, and the like. The gNB 402 may reconfigure the UE measurement parameters, such as T310, T311 or other L1/L3 measurement parameters through RRCReconfiguration. At 490, the UE 401 and the gNB 402 may perform and complete RRCReconfiguration and return to procedure 460 to repeat procedures 460-480.

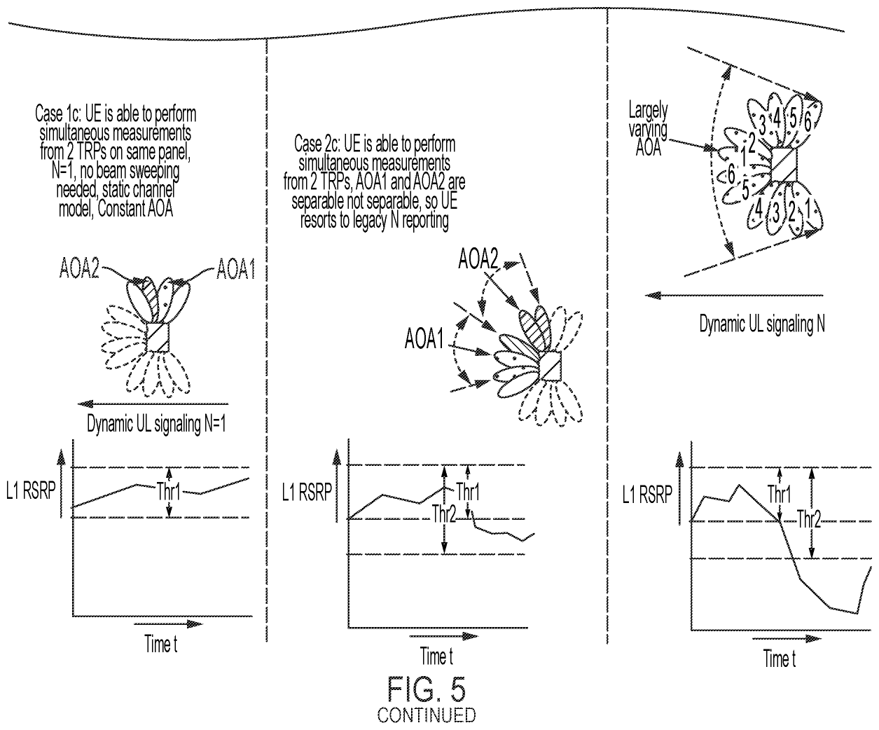

Certain exemplary embodiments may the dynamic beam sweeping factor N_fac may be evaluated in various exemplary scenarios. FIG. 5 illustrates various examples of configurations related to reporting dynamic beam sweeping factor N_fac, according to certain exemplary embodiments. As an example (Case 1), the UE may have so called very low mobility, such that a radio condition for the UE may not change, or change an insignificant amount, which may result in a constant AOA. For example, the AOA may be delta L1-RSRP<Thr-1. The UE may report the dynamic beam sweeping factor N_fac as N=1, wherein no beam sweeping may be required. As another example (Case 2), the UE may have so called medium mobility, such that the radio condition for the UE may slightly change to result in a small variation in AOA. For example, the AOA may be delta L1-RSRP<Thr-2. The UE may use adjacent beam sweeping and may report the dynamic beam sweeping factor N_fac as N=3. As a further example (Case 3), the UE may have so called high mobility, such that the radio condition for the UE may significantly change resulting in a larger variation in AOA. For example, the AOA may be delta L1-RSRP>Thr-2. The UE may use partial or full hierarchical beam sweeping and may report the dynamic beam sweeping factor N_fac as N=X, where X∈[4,12].

Some exemplary embodiments may provide that the UE may have simultaneousReceptionDiffTypeD-r16 capability. As shown in FIG. 5, in a Case 1a and Case 1b, which have so called very low mobility, the radio condition for the UE may not change resulting in a constant AOA. For example, the AOA may be delta L1-RSRP<Thr-1. The UE may report the dynamic beam sweeping factor N_fac as N=1, wherein no beam sweeping may be required. In a Case 2b, the AOA may be separable and have so called medium mobility, wherein the UE may perform simultaneous measurements on two TRPs. In Case 2b, the radio condition for the UE may be slightly changing resulting in a small variation in AOA. For example, the AOA may be delta L1-RSRP<Thr-2. The UE may use adjacent beam sweeping and may report the dynamic beam sweeping factor N_fac as N=3. In a Case 2c, the AOA may not be separable, and the UE may revert to legacy reporting. In a Case Mb, which may have so called high mobility, the radio condition for the UE may be significantly changing resulting in a larger variation in AOA. For example, the AOA may be delta L1-RSRP>Thr-2. The UE may require partial or full hierarchical beam sweeping and may report the dynamic beam sweeping factor N_fac as N=X, where X∈[2,6]. Case Mb as compared to Case M may provide a reduction in the impact of the dynamic beam sweeping factor N_fac as the UE supports simultaneous Rx.

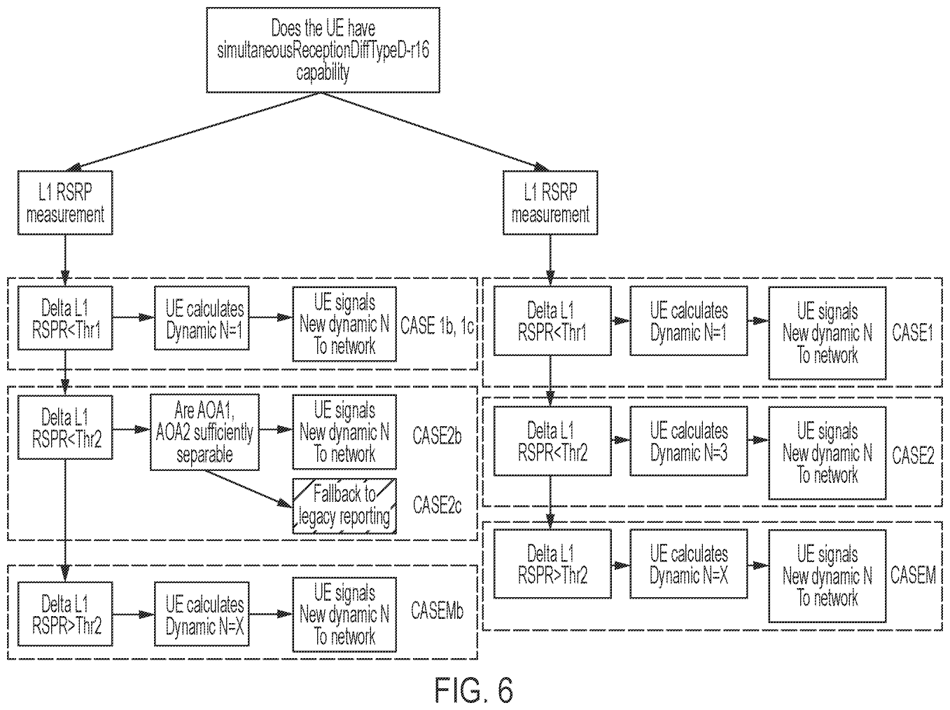

FIG. 6 illustrates an exemplary flow diagram of the examples of FIG. 5, according to various exemplary embodiments. The description of FIG. 5 may apply to the exemplary flow in FIG. 6. FIG. 6 shows that the UE may determine whether the UE has simultaneousReceptionDiffTypeD-r16 capability. If the UE has simultaneousReceptionDiffTypeD-r16 capability, the UE may perform LI RSRP measurements. The change (delta) of the L1 RSRP measurement may be compared to various thresholds, such as threshold Thr1, Thr2, and Thr 3, which determines which case (e.g., Case 1, 1b, 1c, 2, 2b, 2c, M, and Mb) may be implemented.

Various exemplary embodiments may provide that a value of the dynamic beam sweeping factor N_fac may be directly proportional to a total duration of the measurements, which may be significantly reduced by taking advantage of the possibility to perform reporting of the dynamic beam sweeping factor N_fac. For example, Table 5 and Table 6 below show examples of a percentage of savings/reduction in radio link quality evaluation times while using a dynamic beam sweeping factor N_fac.

TABLE 5

| | | | | N | N | | | | |
|---|---|---|---|---|---|---|---|---|---|
| | | | | (legacy | (legacy | | | | |
| | | | | FR2-1 | FR2-2 | | | | |
| TSSB | xRP | TSMTC | MGRP | UE) | UE) | Nfac | | | |
| 20 | 40 | 80 | 40 | 8 | 12 | 1 | 3 | 4 | 6 |
| 20 | 80 | 40 | 80 | 8 | 12 | 1 | 3 | 4 | 6 |

TABLE 6

| | | | | % Saving in link | | | | % Saving in link | | | |
|---|---|---|---|---|---|---|---|---|---|---|---|
| | | | | evaluation time due to | | | | evaluation time due to | | | |
| | | | | Nfac compared to legacy | | | | Nfac compared to legacy | | | |
| TSSB | xRP | TSMTC | MGRP | FR2-1 UE | | | | FR2-2 UE | | | |
| 20 | 40 | 80 | 40 | 88.5% | 62.5% | 50% | 25% | 91.67% | 75% | 66.67% | 50% |
| 20 | 80 | 40 | 80 | 88.5% | 62.5% | 50% | 25% | 91.67% | 75% | 66.67% | 50% |

As may be evidenced by Table 5 and Table 6, the dynamic beam sweeping factor N_fac may have a significant impact on link evaluation time. For example, there may be up to an 88.5% saving/reduction for FR2-1 UE and 91.67% saving/reduction for FR2-2 UE in radio link quality evaluation times while using a dynamic beam sweeping factor N_fac.

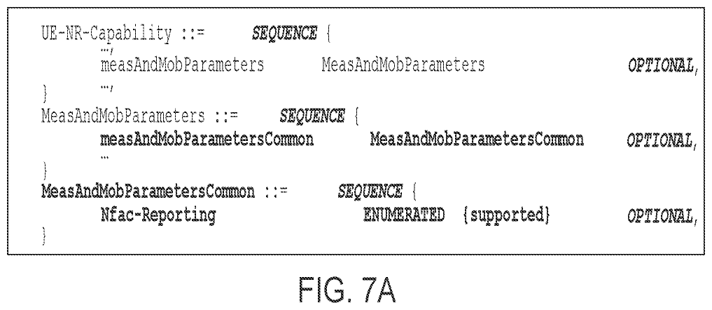

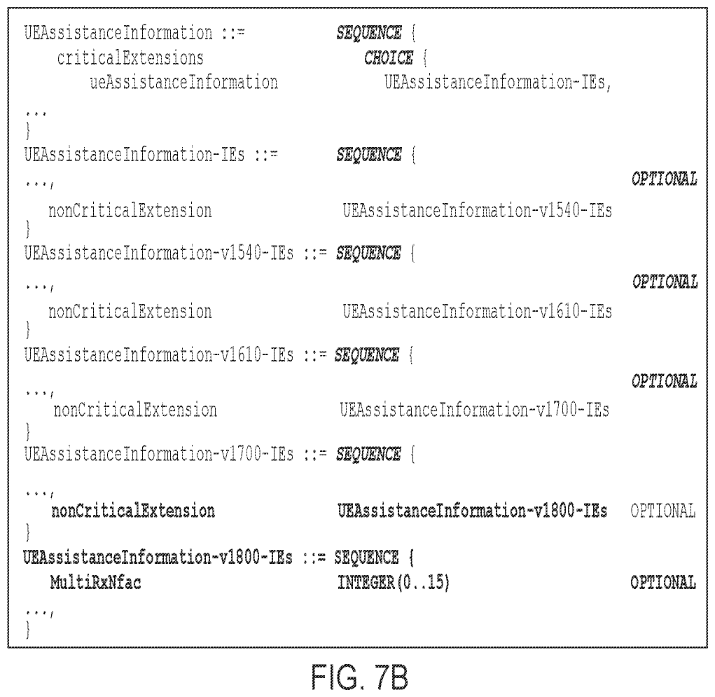

Various exemplary embodiments may provide that a base station, such as a gNB, may indicate for the UE that the UE may send a message or indication of dynamic beam sweeping factor N_fac, UE capabilities, such as via UECapabilityInformation, and UEAssistanceInformation. FIGS. 7A and 7B illustrates examples of network protocol messages, according to certain exemplary embodiments. FIG. 7A illustrates an example of a network protocol message that may include the UECapabilityInformation to signal UE capability for reporting the dynamic beam sweeping factor N_fac, according to some exemplary embodiments. FIG. 7B illustrates an example of a network protocol message that may include the UEAssistanceInformation to report the dynamic beam sweeping factor N_fac to the gNB, according to some exemplary embodiments.

Some exemplary embodiments may provide that measurement times may be calculated/updated based on dynamic beam sweeping factor N_fac, which may be updated as compared to the beam sweeping factor N. For example, T_{Evaluate_out_SSB} and T_{Evaluate_in_SSB} may be recalculated/updated for the UE that supports a multi-Rx dynamic beam sweeping factor N_fac indicated/reported through UEAssistanceInformation.

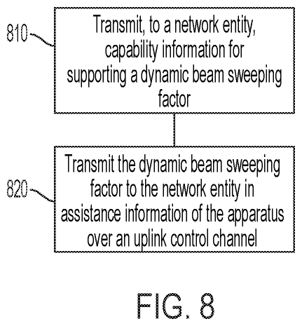

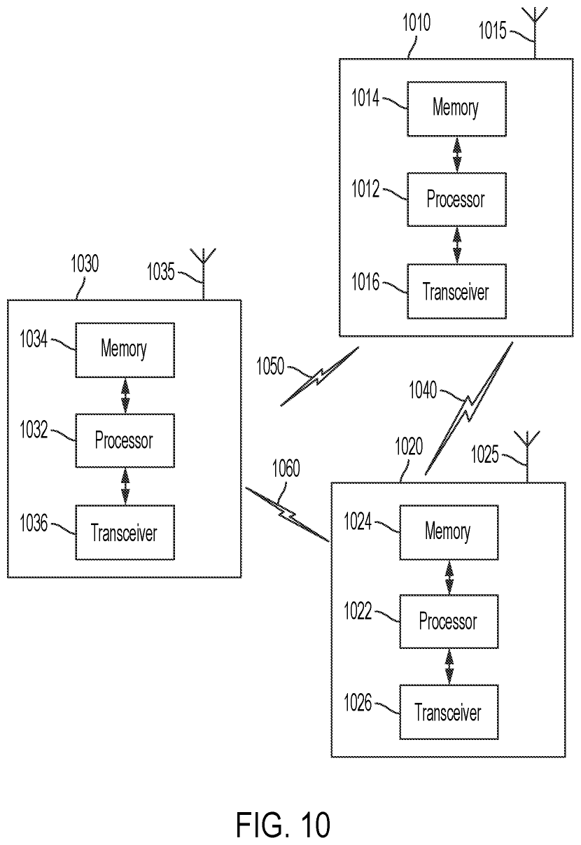

FIG. 8 illustrates an example flow diagram of a method, according to certain exemplary embodiments. In an example embodiment, the method of FIG. 8 may be performed by a network element, or a group of multiple network elements in a 3GPP system, such as LTE or 5G-NR. For instance, in an exemplary embodiment, the method of FIG. 8 may be performed by a user device, mobile device, etc., such as a UE, similar to apparatus 1010 illustrated in FIG. 10.

According to various exemplary embodiments, the method of FIG. 8 may include, at 810, transmitting, to a network entity similar to apparatus 1020, capability information for supporting a dynamic beam sweeping factor by the apparatus 1010. The dynamic beam sweeping factor may be adaptable over a range of values. At 820, the method may include transmitting the dynamic beam sweeping factor to the network entity in assistance information of the apparatus over an uplink control channel.

Certain exemplary embodiments may provide that the assistance information may include an indication that the apparatus has multiple reception capabilities over the uplink control channel. The uplink control channel may be an uplink dedicated control channel. The capability information for supporting the dynamic beam sweeping factor by the apparatus 1010 may be transmitted in a capability information message to the network entity.

Various exemplary embodiments may provide that the method may further include receive, from the network entity, a network capability in which the network informs the apparatus that the dynamic beam sweeping factor is supported by the network entity. Certain exemplary embodiments may provide that the method may further include receiving, from the network entity, a radio resource control reconfiguration message to reconfigure measurement parameters of the apparatus 1010. The measurement parameters may include one or more of the following: a T310 timer value, a T311 timer value, a synchronization signal block-based measurement timing configuration periodicity value, or a reference signal received power reporting periodicity. The method may also include comparing the dynamic beam sweeping factor to a current beam sweeping factor and transmitting the dynamic beam sweeping factor to the network entity upon determining that the dynamic beam sweeping factor is different than the current dynamic beam sweeping factor.

Certain exemplary embodiments may provide that the dynamic beam sweeping factor changes over time due to movement of the apparatus 1010. The dynamic beam sweeping factor may be calculated based on at least one of the following: a beam sweeping strategy, one or more current active transmission control indicator states and a corresponding angle of arrival, a spatial relationship of one or more reference signals, or one or more radio conditions. The method may also include determining an optimum factor to report to the network entity based on a simultaneous reception capability, separation between signals, and a mobility scenario of the apparatus 1010.

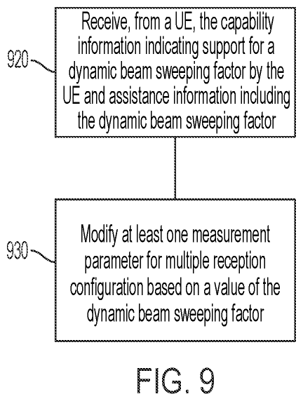

FIG. 9 illustrates an example flow diagram of a method, according to certain exemplary embodiments. In an example embodiment, the method of FIG. 9 may be performed by a network element, or a group of multiple network elements in a 3GPP system, such as LTE or 5G-NR. For instance, in an exemplary embodiment, the method of FIG. 9 may be performed by a network device or network entity, such as a base station or gNB, similar to apparatus 1020 illustrated in FIG. 10.

According to various exemplary embodiments, the method of FIG. 9 may include, at 910, receiving, from a user equipment, capability information indicating support for a dynamic beam sweeping factor by the user equipment, and assistance information comprising the dynamic beam sweeping factor. The dynamic beam sweeping factor may be adaptable over a range of values. At 920, the method may also include modifying at least one measurement parameter for multiple reception configuration based on a value of the dynamic beam sweeping factor.

Some exemplary embodiments may provide that the method may also include transmitting, to the user equipment, a request for capability information of the user equipment. The method further include transmitting, to the user equipment, capability information indicating that the apparatus supports the dynamic beam sweeping factor. The dynamic beam sweeping factor may change over time due to movement of the user equipment or due to a change in a radio environment. The dynamic beam sweeping factor may be based on at least one of the following: a beam sweeping strategy, one or more current active transmission control indicator states and a corresponding angle of arrival, a spatial relationship of one or more reference signals, or one or more radio conditions. The assistance information may include an indication that the user equipment has multiple reception capabilities over the control channel. The control channel may be an uplink dedicated control channel.

Certain exemplary embodiments may provide that the method may further include transmitting, to the user equipment, a capability with the dynamic beam sweeping factor. The capability may be a radio resource control reconfiguration comprising a multiple reception configuration. The method may also include transmitting, to the user equipment, a radio resource control reconfiguration message to reconfigure one or more measurement parameters of the apparatus based on the modified at least one measurement parameter. The measurement parameters may include one or more of the following: a T310 timer value, a T311 timer value, a synchronization signal block-based measurement timing configuration periodicity value, or a reference signal received power reporting periodicity.

Various exemplary embodiments may provide that the dynamic beam sweeping factor is received upon the dynamic beam sweeping factor being different than the current dynamic beam sweeping factor. The method may further include receiving, from the user equipment, an optimum factor based on a simultaneous reception capability, separation between signals, and a mobility scenario of the user equipment.

FIG. 10 illustrates apparatuses 1010, 1020, and 1030 according to various exemplary embodiments. In the various exemplary embodiments, apparatus 1010 may be an element in a communications network or associated with such a network, such as a UE, RedCap UE, SL UE, mobile equipment (ME), mobile station, mobile device, stationary device, IoT device, or other device. UE 401 may be an example of apparatus 1010 according to various exemplary embodiments as discussed above. It should be noted that one of ordinary skill in the art would understand that apparatus 1010 may include components or features not shown in FIG. 10. Further, the apparatus 1020 may be a network entity, element of the core network, or element in a communications network or associated with such a network, such as a base station, an NE, or a gNB. For example, gNB 402 may be an example of apparatus 1020 according to various exemplary embodiments as discussed above. It should be noted that one of ordinary skill in the art would understand that apparatus 1020 may include components or features not shown in FIG. 10. In addition, an apparatus 1030 may be a part of the RAN, a network entity or a sub-component or processing functions of a network entity of computation device connected to the network. For example, network 403 may be an example of apparatus 1030 according to various exemplary embodiments as discussed above. It should be noted that one of ordinary skill in the art would understand that apparatus 1030 may include components or features not shown in FIG. 10.

Various exemplary embodiments may advantageously provide one or more procedures to provide one or more procedures for optimizing a beam sweeping factor N for a mobile UE using a dynamic beam sweeping factor N_fac. Certain exemplary embodiments may provide advantages that allow for a UE having multi-Rx, multi-panel architectures, and/or supporting independent beam management, to reduce the impact of the beam sweeping factor N during RLM, BFD, and CBD resources for L1 measurements by implementing the dynamic beam sweeping factor N_fac.

According to various exemplary embodiments, the apparatuses 1010, 1020, and/or 1030 may include one or more processors, one or more computer-readable storage medium (for example, memory, storage, or the like), one or more radio access components (for example, a modem, a transceiver, or the like), and/or a user interface. In some exemplary embodiments, apparatuses 1010, 1020, and/or 1030 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 10, apparatuses 1010, 1020, and/or 1030 may include or be coupled to processors 1012, 1022, and 1032, respectively, for processing information and executing instructions or operations. Processors 1012, 1022, and 1032 may be any type of general or specific purpose processor. In fact, processors 1012, 1022, and 1032 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 1012 (1022 and 1032) for each of apparatuses 1010, 1020, and/or 1030 is shown in FIG. 10, multiple processors may be utilized according to other example embodiments. For example, it should be understood that, in certain example embodiments, apparatuses 1010, 1020, and/or 1030 may include two or more processors that may form a multiprocessor system (for example, in this case processors 1012, 1022, and 1032 may represent a multiprocessor) that may support multiprocessing. According to certain example embodiments, the multiprocessor system may be tightly coupled or loosely coupled to, for example, form a computer cluster).

Processors 1012, 1022, and 1032 may perform functions associated with the operation of apparatuses 1010, 1020, and/or 1030, respectively, including, as some examples, precoding of antenna gain/phase parameters, encoding and decoding of individual bits forming a communication message, formatting of information, and overall control of the apparatuses 1010, 1020, and/or 1030, including processes illustrated in FIGS. 4-9.

Apparatuses 1010, 1020, and/or 1030 may further include or be coupled to memory 1014, 1024, and/or 1034 (internal or external), respectively, which may be coupled to processors 1012, 1022, and 1032, respectively, for storing information and instructions that may be executed by processors 1012, 1022, and 1032. Memory 1014 (memory 1024 and 1034) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 1014 (memory 1024 and 1034) can be comprised of any combination of random access memory (RAM), read only memory (ROM), static storage such as a magnetic or optical disk, hard disk drive (HDD), or any other type of non-transitory machine or computer readable media. The instructions stored in memory 1014, memory 1024, and memory 1034 may include program instructions or computer program code that, when executed by processors 1012, 1022, and 1032, enable the apparatuses 1010, 1020, and/or 1030 to perform tasks as described herein.

In certain example embodiments, apparatuses 1010, 1020, and/or 1030 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 1012, 1022, and 1032 and/or apparatuses 1010, 1020, and/or 1030 to perform any of the methods illustrated in FIGS. 4-9.

In some exemplary embodiments, apparatuses 1010, 1020, and/or 1030 may also include or be coupled to one or more antennas 1015, 1025, and 1035, respectively, for receiving a downlink signal and for transmitting via an uplink from apparatuses 1010, 1020, and/or 1030. Apparatuses 1010, 1020, and/or 1030 may further include transceivers 1016, 1026, and 1036, respectively, configured to transmit and receive information. The transceivers 1016, 1026, and 1036 may also include a radio interface (for example, a modem) respectively coupled to the antennas 1015, 1025, and 1035. The radio interface may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 1016, 1026, and 1036 may be respectively configured to modulate information on to a carrier waveform for transmission by the antenna(s) 1015, 1025, and 1035, and demodulate information received via the antenna(s) 1015, 1025, and 1035 for further processing by other elements of apparatuses 1010, 1020, and/or 1030. In other example embodiments, transceivers 1016, 1026, and 1036 may be capable of transmitting and receiving signals or data directly. Additionally or alternatively, in some example embodiments, apparatuses 1010, 1020, and/or 1030 may include an input and/or output device (I/O device). In certain example embodiments, apparatuses 1010, 1020, and/or 1030 may further include a user interface, such as a graphical user interface or touchscreen.

In certain example embodiments, memory 1014, memory 1024, and memory 1034 store software modules that provide functionality when executed by processors 1012, 1022, and 1032, respectively. The modules may include, for example, an operating system that provides operating system functionality for apparatuses 1010, 1020, and/or 1030. The memory may also store one or more functional modules, such as an application or program, to provide additional functionality for apparatuses 1010, 1020, and/or 1030. The components of apparatuses 1010, 1020, and/or 1030 may be implemented in hardware, or as any suitable combination of hardware and software. According to certain example embodiments, apparatus 1010 may optionally be configured to communicate with apparatus 1020 and/or 1030 via a wireless or wired communications links 1040, 1050, and/or 1060 according to any radio access technology, such as NR.

According to certain example embodiments, processors 1012, 1022, and 1032, and memory 1014, 1024, and 1034 may be included in or may form a part of processing circuitry or control circuitry. In addition, in some example embodiments, transceivers 1016, 1026, and 1036 may be included in or may form a part of transceiving circuitry.

For instance, in certain exemplary embodiments, the apparatus 1010 may be controlled by the memory 1014 and the processor 1012 to transmit, to a network entity, capability information for supporting a dynamic beam sweeping factor by the apparatus. The dynamic beam sweeping factor may be adaptable over a range of values. The apparatus 1010 may be further caused to transmit the dynamic beam sweeping factor to the network entity in assistance information of the apparatus over an uplink control channel.

In various exemplary embodiments, the apparatus 1020 may be controlled by the memory 1024 and the processor 1022 to receive, from a user equipment, capability information indicating support for a dynamic beam sweeping factor by the user equipment, and assistance information comprising the dynamic beam sweeping factor. The dynamic beam sweeping factor may be adaptable over a range of values. The apparatus may further be caused to modify at least one measurement parameter for multiple reception configuration based on a value of the dynamic beam sweeping factor.

In some exemplary embodiments, an apparatus (e.g., apparatus 1010, apparatus 1020, and/or apparatus 1030) may include means for performing a method, a process, or any of the variants discussed herein. Examples of the means may include one or more processors, memory, controllers, transmitters, receivers, and/or computer program code for causing the performance of the operations.

Various exemplary embodiments may be directed to an apparatus, such as apparatus 1010, that includes means for transmitting, to a network entity, capability information for supporting a dynamic beam sweeping factor by the apparatus. The dynamic beam sweeping factor may be adaptable over a range of values. The apparatus 1010 may also include means for transmitting the dynamic beam sweeping factor to the network entity in assistance information of the apparatus over an uplink control channel.

Various exemplary embodiments may be directed to an apparatus, such as apparatus 1020, that includes means for receiving, from a user equipment, capability information indicating support for a dynamic beam sweeping factor by the user equipment, and assistance information including the dynamic beam sweeping factor. The dynamic beam sweeping factor may be adaptable over a range of values. The apparatus 1020 may also include means for modifying at least one measurement parameter for multiple reception configuration based on a value of the dynamic beam sweeping factor.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 1010, 1020, and/or 1030) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 1010, 1020, and/or 1030), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
AOA Angle of Arrival
BFD Beam Failure Detection
COMB Combiner
CSI Channel State Information
DL Downlink
EMBB Enhanced Mobile Broadband
FR1 Frequency Range 1
FR2 Frequency Range 2
gNB 5G or Next Generation NodeB
L1 Layer 1
LNA Low Noise Amplifier
LTE Long Term Evolution
MGRP Measurement Gap Repetition Period
MIMO Multiple Input Multiple Output
N Beam Sweeping Factor
Nfrac Dynamic Beam Sweeping Factor
NR New Radio
PA Power Amplifier
PHS Bi-Directional Phase Shifter
PRS Positioning Reference Signal
QCL Quasi Colocation
RAN Radio Access Network
RedCap Reduced Capability
RLM Radio Link Monitoring
RRC Radio Resource Control
RSRP Reference Signal Received Power
SMTC SSB-Based Measurement Timing Configuration
SSB Synchronization Signal Block
TCI Transmission Configuration Indicator
TDD Time Division Duplex
TRP Transmission Reception Point
UE User Equipment
UL Uplink

We claim:

1. An apparatus, comprising:
at least one processor; and
at least one memory storing instructions that, when executed by the at least one processor, cause the apparatus at least to:
transmit, to a network entity, capability information for supporting a dynamic beam sweeping factor by the apparatus, wherein the dynamic beam sweeping factor is adaptable over a range of values; and
transmit the dynamic beam sweeping factor to the network entity in assistance information of the apparatus over an uplink control channel.

2. The apparatus according to claim 1, wherein the assistance information comprises an indication that the apparatus has multiple reception capabilities over the uplink control channel, wherein the uplink control channel is an uplink dedicated control channel.

3. The apparatus according to claim 1, wherein the capability information for supporting the dynamic beam sweeping factor by the apparatus is transmitted in a capability information message to the network entity.

4. The apparatus according to claim 1, wherein the apparatus is further caused to:
receive, from the network entity, a network capability in which the network informs the apparatus that the dynamic beam sweeping factor is supported by the network entity.

5. The apparatus according to claim 4, wherein the apparatus is further caused to:
receive, from the network entity, a radio resource control reconfiguration indicating to the apparatus to perform multiple reception.

6. The apparatus according to claim 1, wherein the apparatus is further caused to:
receive, from the network entity, a radio resource control reconfiguration message to reconfigure measurement parameters of the apparatus.

7. The apparatus according to claim 6, wherein the measurement parameters comprise one or more of the following: a T310 timer value, a T311 timer value, a synchronization signal block-based measurement timing configuration periodicity value, or a reference signal received power reporting periodicity.

8. The apparatus according to claim 1, wherein the apparatus is further caused to:
compare the dynamic beam sweeping factor to a current dynamic beam sweeping factor; and
transmit the dynamic beam sweeping factor to the network entity upon determining that the dynamic beam sweeping factor is different than the current dynamic beam sweeping factor.

9. The apparatus according to claim 1, wherein the dynamic beam sweeping factor changes over time due to movement of the apparatus or due to a change in a radio environment.

10. The apparatus according to claim 1, wherein the dynamic beam sweeping factor is calculated based on at least one of the following:
a beam sweeping strategy;
one or more current active transmission control indicator states and a corresponding angle of arrival;
a spatial relationship of one or more reference signals; or
one or more radio conditions.

11. The apparatus according to claim 1, wherein the apparatus is further caused to:
determine an optimum factor to report to the network entity based on a simultaneous reception capability, separation between signals, and a mobility scenario of the apparatus.

12. An apparatus, comprising:
at least one processor; and
at least one memory storing instructions that, when executed by the at least one processor, cause the apparatus at least to:
receive, from a user equipment, capability information indicating support for a dynamic beam sweeping factor by the user equipment, and assistance information comprising the dynamic beam sweeping factor, wherein the dynamic beam sweeping factor is adaptable over a range of values; and
modify at least one measurement parameter for multiple reception configuration based on a value of the dynamic beam sweeping factor.

13. The apparatus according to claim 12, wherein the apparatus is further caused to:
transmit, to the user equipment, a request for capability information of the user equipment.

14. The apparatus according to claim 12, wherein the apparatus is further caused to:
transmit, to the user equipment, capability information indicating that the apparatus supports the dynamic beam sweeping factor.

15. The apparatus according to claim 12, wherein the assistance information comprises an indication that the user equipment has multiple reception capabilities over the control channel, wherein the control channel is an uplink dedicated control channel.

16. The apparatus according to claim 12, wherein the apparatus is further caused to:
transmit, to the user equipment, a capability information message with the dynamic beam sweeping factor, wherein the capability information message is a radio resource control reconfiguration message comprising a multiple reception configuration.

17. The apparatus according to claim 12, wherein the apparatus is further caused to:
transmit, to the user equipment, a radio resource control reconfiguration message to reconfigure one or more measurement parameters of the apparatus based on the modified at least one measurement parameter; and
wherein the one or more measurement parameters comprise one or more of the following: a T310 timer value, a T311 timer value, a synchronization signal block-based measurement timing configuration periodicity value, or a reference signal received power reporting periodicity.

18. The apparatus according to of claim 12, wherein the dynamic beam sweeping factor is received upon the dynamic beam sweeping factor being different than the current dynamic beam sweeping factor.

19. The apparatus according to of claim 12, wherein the apparatus is further caused to:
receive, from the user equipment, an optimum dynamic beam sweeping factor based on a simultaneous reception capability, separation between signals, and a mobility scenario of the user equipment or a change in a radio environment.

20. A method, comprising:
transmitting, to a network entity, capability information for supporting a dynamic beam sweeping factor by an apparatus, wherein the dynamic beam sweeping factor is adaptable over a range of values; and
transmitting the dynamic beam sweeping factor to the network entity in assistance information of the apparatus over an uplink control channel.
